(19) United States
(12) Patent Application Publication
(10) Pub. No.: US 2019/0338590 A1
(43) Pub. Date: Nov. 7, 2019

(54) Ladder with system opening facilitator

(71) Applicant: Louisville Ladder Inc., Louisville, KY (US)

(72) Inventor: Carlos Andrés Rodríguez Garza, San Nicolas de los Garza (MX)

(21) Appl. No.: 15/971,965

(22) Filed: May 4, 2018

(51) Int. Cl. E06C 1/16; E06C 1/393; E06C 1/20; E06C 7/00

(52) U.S. Cl. CPC E06C 1/16; E06C 7/00; E06C 1/20; E06C 1/393

(57) ABSTRACT

The present disclosure is directed to a ladder system. A ladder system may comprise a first section comprising: a first rail, a second rail, and a first support connected to the first rail and the second rail; a second section comprising a first leg; a first connector for connecting, either directly or indirectly via one or more second connectors, the first section to the second section; and a ladder system-opening facilitator connected to the first section and the second section, wherein the first section is substantially parallel to the second section when the ladder system is in a closed position, wherein the ladder system-opening facilitator automatically completes an opening action for the ladder system in response to initiation of the opening action, and wherein the first section is angular to the second section when the ladder system is in an open position.

### CROSS-REFERENCE TO RELATED APPLICATIONS

This application incorporates by reference two design applications entitled “Four-Legged Ladder With System Opening Facilitator” and “Three-Legged Ladder With System Opening Facilitator”, both filed the same day as this application.

### TECHNICAL FIELD

This disclosure generally relates to ladders.

### BACKGROUND

Ladders may be used in order to facilitate access to and support activity in places above the ground and/or floor. Ladders may be used outdoors and/or indoors. Ladders may be used for business and/or personal activity, or any other activities not listed in this disclosure.

### SUMMARY

In some embodiments, a ladder system may comprise a first section comprising: a first rail, a second rail, and a first support (e.g., a first step) connected to the first rail and the second rail; a second section comprising a first leg; a first connector for connecting, either directly or indirectly via one or more second connectors, the first section to the second section; and a ladder system-opening facilitator connected to the first section and the second section, wherein the first section is substantially parallel to the second section when the ladder system is in a closed position, wherein the ladder system-opening facilitator automatically completes an opening action for the ladder system in response to initiation of the opening action, and wherein the first section is angular to the second section when the ladder system is in an open position.

In some embodiments with a ladder system, the initiation of the opening action comprises application of first force to at least one of the first section or the second section.

In some embodiments with a ladder system, the first force is provided by a source external to the ladder system.

In some embodiments with a ladder system, the first force is less than a second force for both initiating and completing the opening action.

In some embodiments with a ladder system, the first force is less than a second force for completing the opening action.

In some embodiments with a ladder system, the ladder system-opening facilitator provides a force for automatically completing the opening action.

In some embodiments with a ladder system, the first connector or the one or more second connectors comprises at least one of a cap, a platform, a step, a plate, a brace, a hinge, or a rivet.

In some embodiments with a ladder system, the first support is positioned substantially perpendicularly to at least one of the first rail or the second rail.

In some embodiments with a ladder system, the first connector or the one or more second connectors is positioned near an edge of at least one of the first section or the second section.

In some embodiments with a ladder system, the ladder system comprises a step ladder system.

In some embodiments with a ladder system, the ladder system comprises a platform ladder system.

In some embodiments with a ladder system, the ladder system-opening facilitator is connected to the first rail and the first leg.

In some embodiments with a ladder system, the ladder system-opening facilitator is connected to the first support and the first leg.

In some embodiments with a ladder system, the first leg comprises a third rail, wherein the second section further comprises a fourth rail and a second support, and wherein the second support is connected to the third rail and the fourth rail.

In some embodiments with a ladder system, the ladder system-opening facilitator is connected to the first rail and the third rail.

In some embodiments with a ladder system, the ladder system-opening facilitator is connected to the first rail and the fourth rail.

In some embodiments with a ladder system, the ladder system-opening facilitator is connected to the first support and the second support.

In some embodiments with a ladder system, the ladder system-opening facilitator comprises a gas strut.

In some embodiments with a ladder system, the ladder system opening facilitator comprises a compressible mechanical device and/or resilient material that can provide outward force.

In some embodiments with a ladder system, the ladder system-opening facilitator comprises an electric motor.

In some embodiments with a ladder system, the ladder system-opening facilitator comprises a spring.

In some embodiments with a ladder system, the ladder system-opening facilitator comprises multiple ladder system-opening facilitators.

In some embodiments with a ladder system, the multiple ladder system-opening facilitators are substantially parallel to each other.

In some embodiments with a ladder system, the multiple ladder system-opening facilitators are substantially in series to each other.

In some embodiments, the ladder system may further comprise a spreader.

In some embodiments, the ladder system-opening facilitator is located above the spreader.

In some embodiments, the ladder system-opening facilitator is located below the spreader.

In some embodiments, the spreader comprises the ladder system-opening facilitator.

In some embodiments, the second section comprises a second leg.

In some embodiments, the second section comprises a second support connected to the first leg and the second leg.

In some embodiments, the ladder system-opening facilitator is connected to the first support and the second support.

In some embodiments, the ladder system-opening facilitator is connected to the first rail and the second support.

In some embodiments, at least a portion of the first section or the second section is manufactured with at least one of aluminum, fiberglass, plastic, or wood.

In some embodiments, the ladder system may further comprise a line connected to at least the second section.

In some embodiments, pulling a portion of the line towards the first section causes the ladder system to enter a closed position.

In some embodiments, a force associated with pulling the portion of the line towards the first section is greater than a resistant force provided by the ladder system-opening facilitator.

In some embodiments, a ladder system may comprise a first section comprising: a first rail, a second rail, and a first support connected to the first rail and the second rail; a second section comprising a first leg; a first connector for connecting, either directly or indirectly via one or more second connectors, the first section to the second section; and a ladder system-opening facilitator connected to the first section and the second section, wherein the first section is substantially parallel to the second section when the ladder system is in a closed state, wherein the first section is at a first angle to the second section when the ladder system is in an initial open state, wherein the ladder system moves from the closed state to the initial open state upon application of external force to at least one of the first section or the second section, wherein the first section is at a second angle to the second section when the ladder system is in a final open state, and wherein the ladder system-opening facilitator causes the ladder system to move from the initial open state to the final open state.

In some embodiments, the ladder-opening facilitator provides force for causing the ladder system to move from the initial open state to the final open state.

In some embodiments, when the ladder system moves to the initial open state, the ladder system-opening facilitator is automatically triggered to cause the ladder system to move from the initial open state to the final open state.

In some embodiments, a ladder system may comprise a first section comprising: a first rail, a second rail, and a first support connected to the first rail and the second rail; a second section comprising a first leg; a first connector for connecting, either directly or indirectly via one or more second connectors, the first section to the second section; and a ladder system-opening facilitator connected to the first section and the second section, wherein in response to first angular displacement between the first section and the second section, the ladder system-opening facilitator automatically causes second angular displacement between the first section and the second section, and wherein the second angular displacement is greater than the first angular displacement.

### BRIEF DESCRIPTION OF THE DRAWINGS

FIG. 1A illustrates a perspective view of a ladder with four rails in an open configuration, in accordance with some embodiments.

FIG. 1B illustrates a top view of a ladder with four rails in an open configuration, in accordance with some embodiments.

FIG. 1C illustrates a bottom view of a ladder with four rails in an open configuration, in accordance with some embodiments.

FIG. 1D illustrates a left view of a ladder with four rails in an open configuration, in accordance with some embodiments.

FIG. 1E illustrates a right view of a ladder with four rails in an open configuration, in accordance with some embodiments.

FIG. 1F illustrates a front view of a ladder with four rails in an open configuration, in accordance with some embodiments.

FIG. 1G illustrates a back view of a ladder with four rails in an open configuration, in accordance with some embodiments.

FIG. 1H illustrates a perspective view of a ladder with four rails in a closed configuration, in accordance with some embodiments.

FIG. 1I illustrates a top view of a ladder with four rails in a closed configuration, in accordance with some embodiments.

FIG. 1J illustrates a bottom view of a ladder with four rails in a closed configuration, in accordance with some embodiments.

FIG. 1K illustrates a left view of a ladder with four rails in a closed configuration, in accordance with some embodiments.

FIG. 1L illustrates a right view of a ladder with four rails in a closed configuration, in accordance with some embodiments.

FIG. 1M illustrates a front view of a ladder with four rails in a closed configuration, in accordance with some embodiments.

FIG. 1N illustrates a back view of a ladder with four rails in a closed configuration, in accordance with some embodiments.

FIG. 2A illustrates a perspective view of a ladder with three rails in an open configuration, in accordance with some embodiments.

FIG. 2B illustrates a top view of a ladder with three rails in an open configuration, in accordance with some embodiments.

FIG. 2C illustrates a bottom view of a ladder with three rails in an open configuration, in accordance with some embodiments.

FIG. 2D illustrates a left view of a ladder with three rails in an open configuration, in accordance with some embodiments.

FIG. 2E illustrates a right view of a ladder with three rails in an open configuration, in accordance with some embodiments.

FIG. 2F illustrates a front view of a ladder with three rails in an open configuration, in accordance with some embodiments.

FIG. 2G illustrates a back view of a ladder with three rails in an open configuration, in accordance with some embodiments.

FIG. 2H illustrates a perspective view of a ladder with three rails in a closed configuration, in accordance with some embodiments.

FIG. 3A illustrates a perspective view of a ladder with four rails in an open configuration, in accordance with some embodiments.

FIG. 3B illustrates a perspective view of a ladder with four rails in a closed configuration, in accordance with some embodiments.

FIG. 4 illustrates a perspective view of a ladder with four rails in an open configuration, in accordance with some embodiments.

### DETAILED DESCRIPTION

It may be convenient (e.g. for transportation purposes) to have ladders that can be configured in more than one configuration. At least one of the configurations may facilitate ladder use, whereas at least one other configuration may facilitate ladder transportation. For example, a self-supporting ladder (i.e. one that can stand upright on its own) may comprise two or more sections that can fold away from each other into an open configuration, or fold toward each other to a closed configuration. A section may comprise or be part of a plane. In some embodiments, a “configuration” may interchangeably refer to a “position” (e.g. open configuration and open position), while in other embodiments “configuration” and “position” may be distinct or one may be a subset of the other. As another example, a ladder intended for use with an external support (e.g. a building that the ladder is leaned on) may comprise two or more parallel sections that may be slidably disposed relative to one another.

It may be convenient and/or safe for a ladder itself to facilitate the configuring of the ladder from one configuration to another configuration. This configuring process may comprise the opening and/or closing of the ladder, and may involve a system-opening facilitator (SOF) that facilitates easier opening of the ladder.

### Figure Terminology

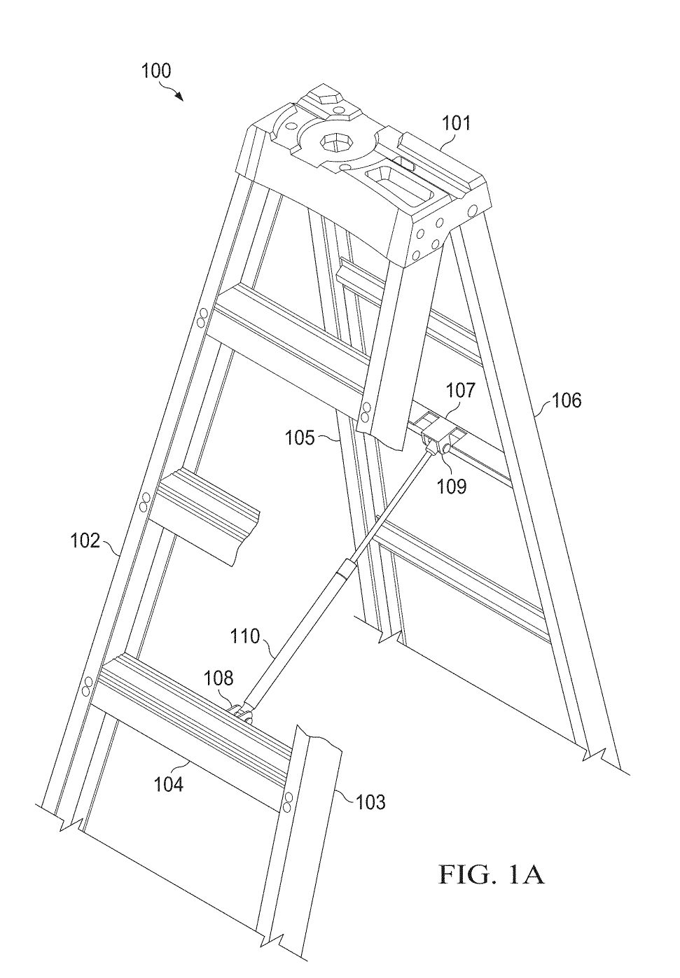

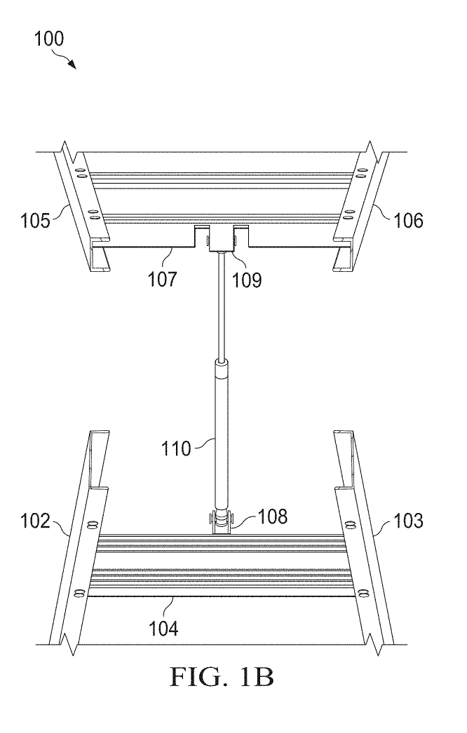

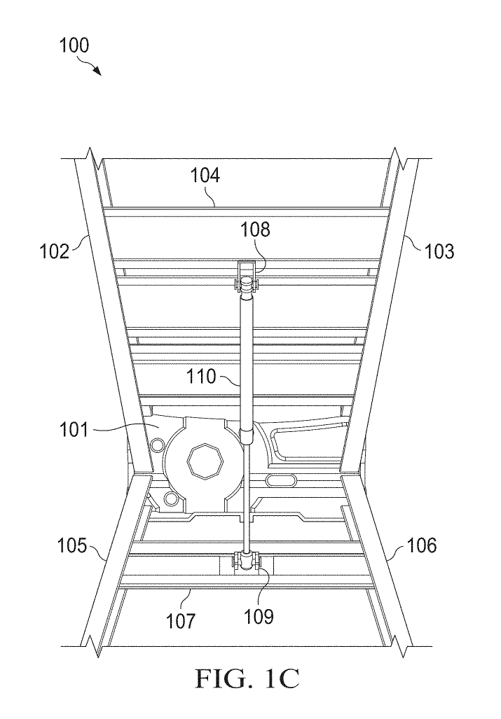

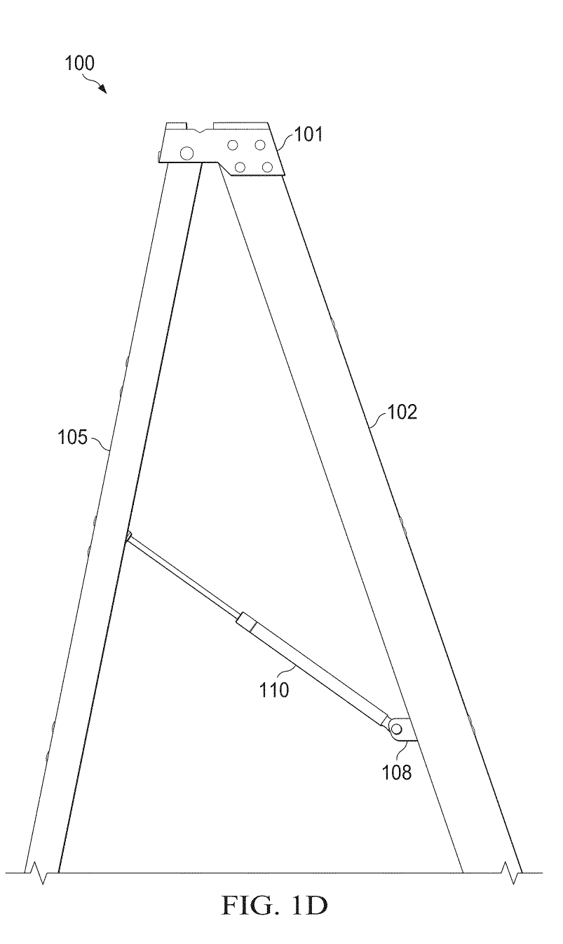

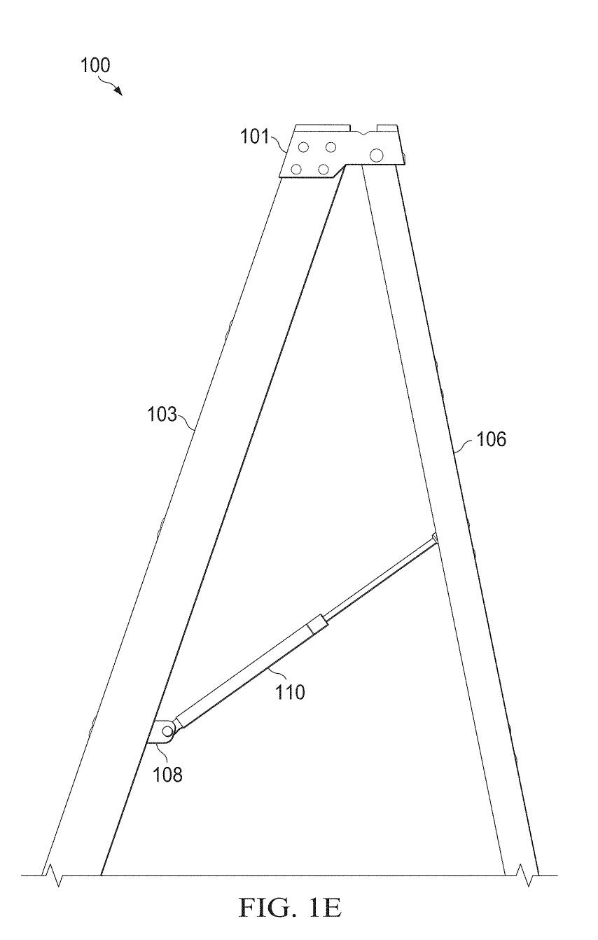

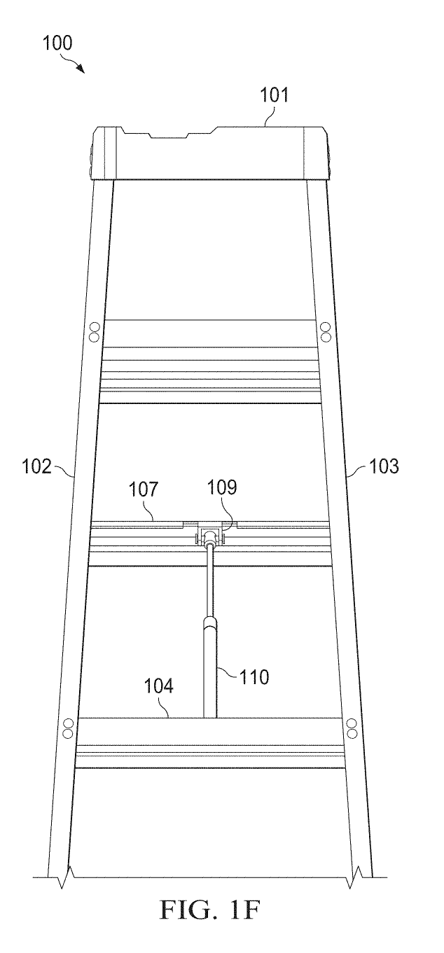

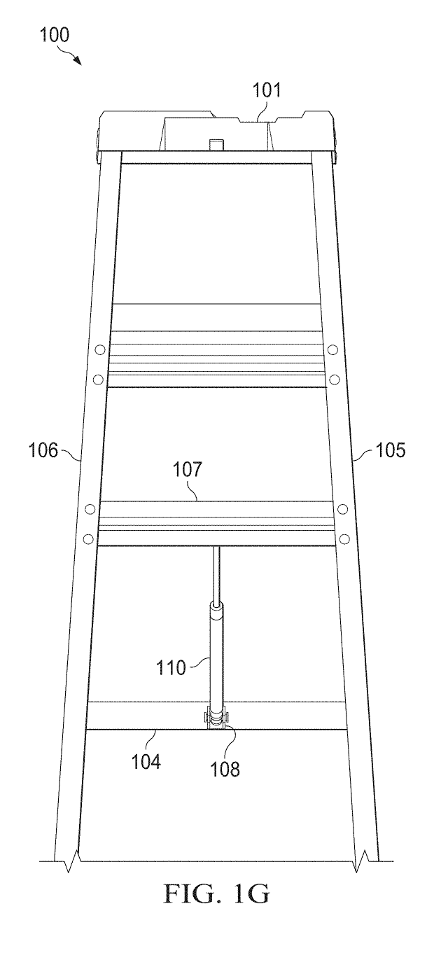

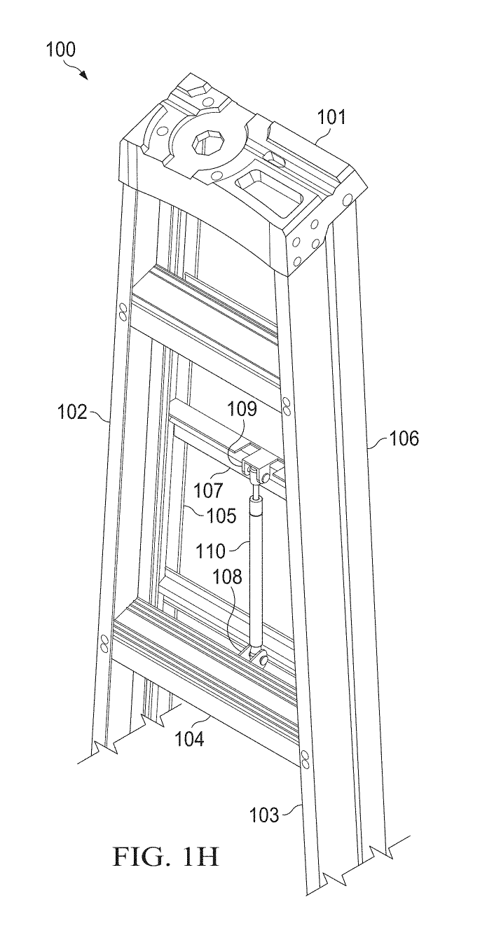

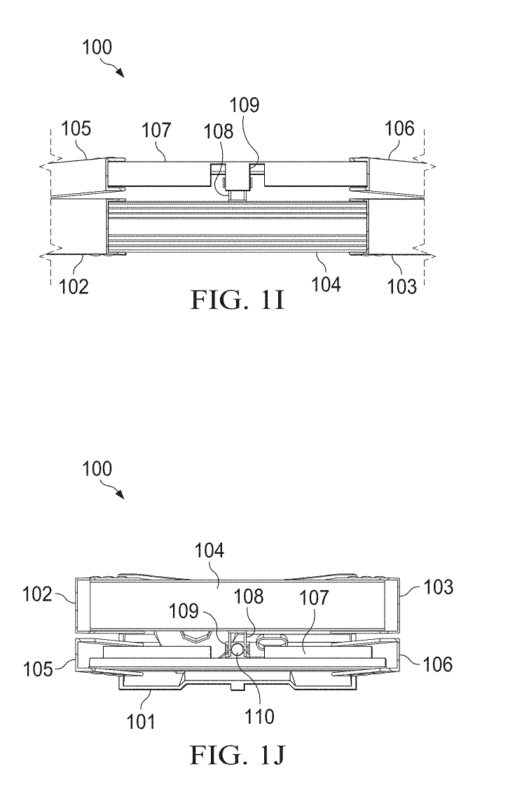

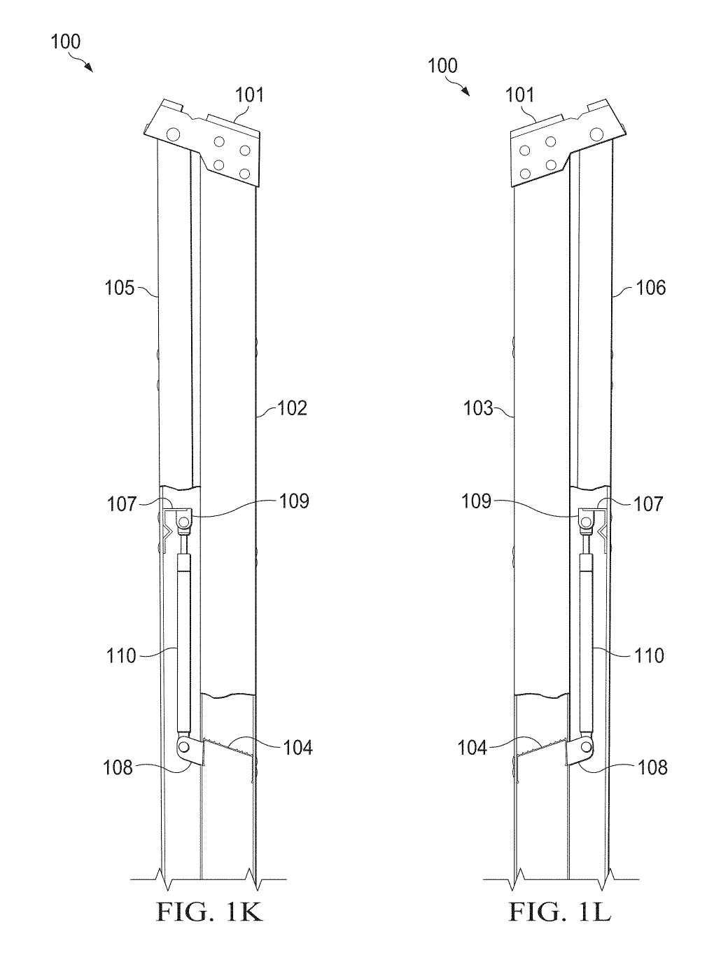

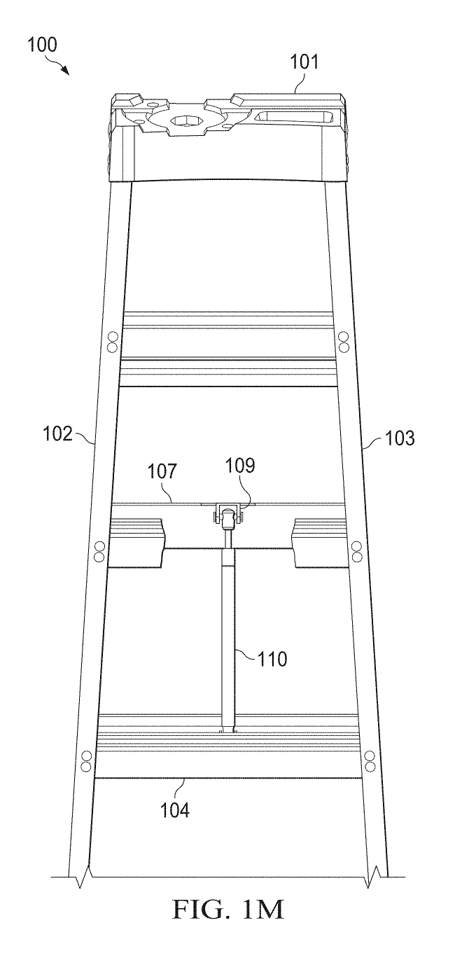

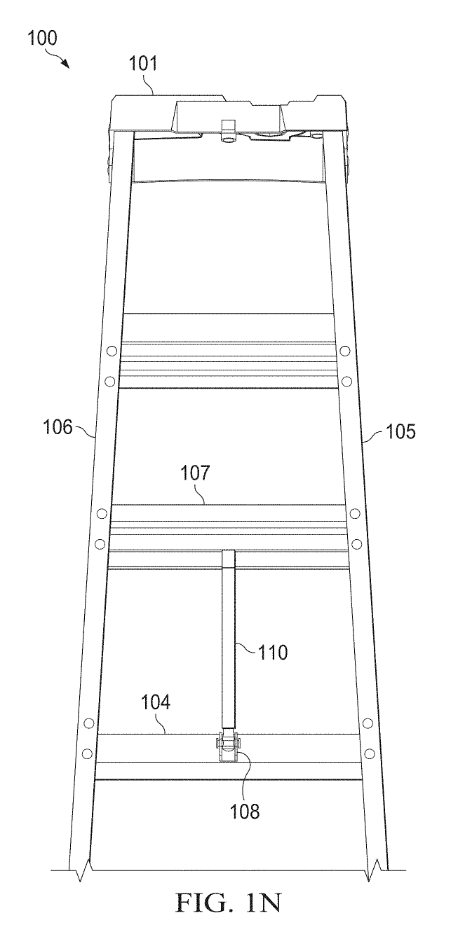

FIG. 1A illustrates a perspective view of a ladder 100 with four rails in an open configuration according to some embodiments, comprising a cap 101, first rail 102 of a first section, second rail 103 of a first section, step 104 of a first section, first rail 105 of a second section, second rail 106 of a second section, brace 107 of a second section, SOF attachment 108 to a first section, SOF attachment 109 to a second section, and SOF 110. FIGS. 1B-1G illustrate different views for the same ladder 100 in an open configuration according to some embodiments, while FIGS. 1H-1N illustrate different views for the same ladder 100 in a closed configuration according to some embodiments. Ladder 100 elements referred to in the description of FIG. 1A are labeled with the same reference numerals in FIGS. 1B-1N where visible.

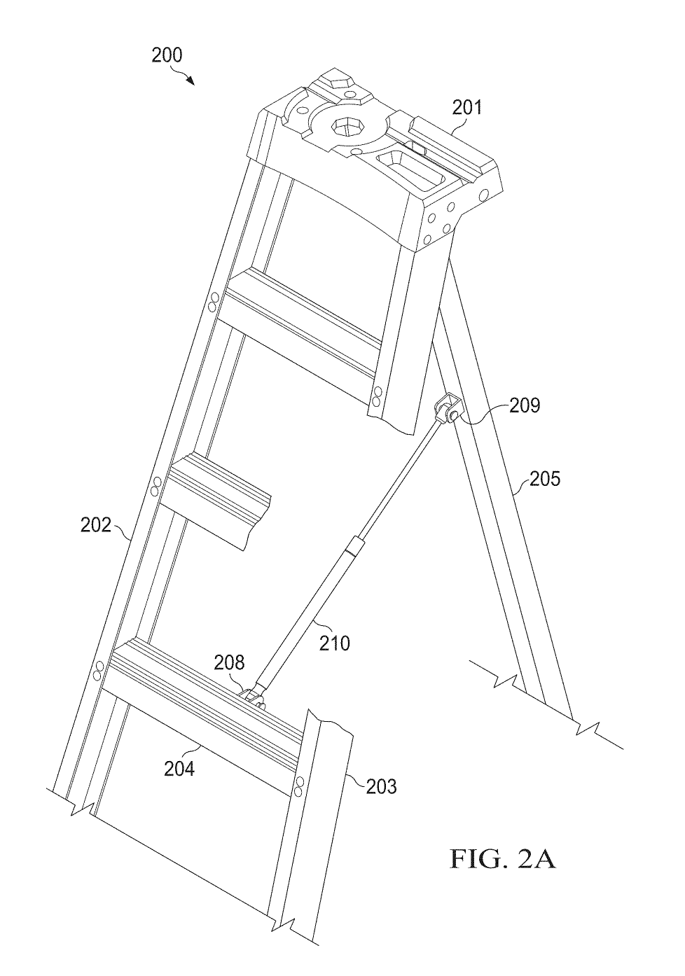

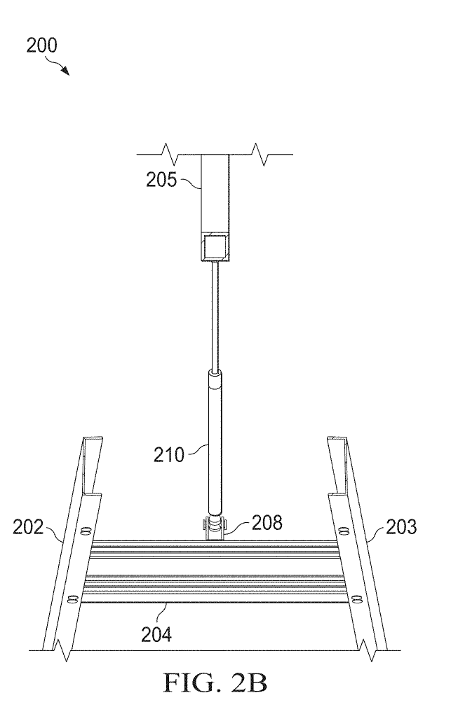

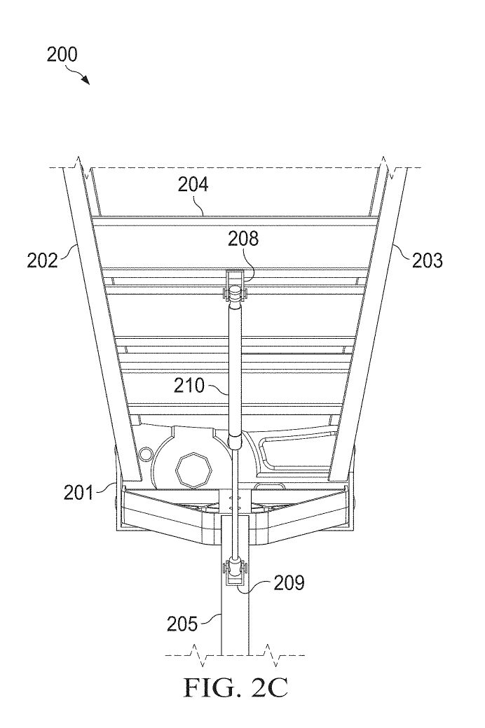

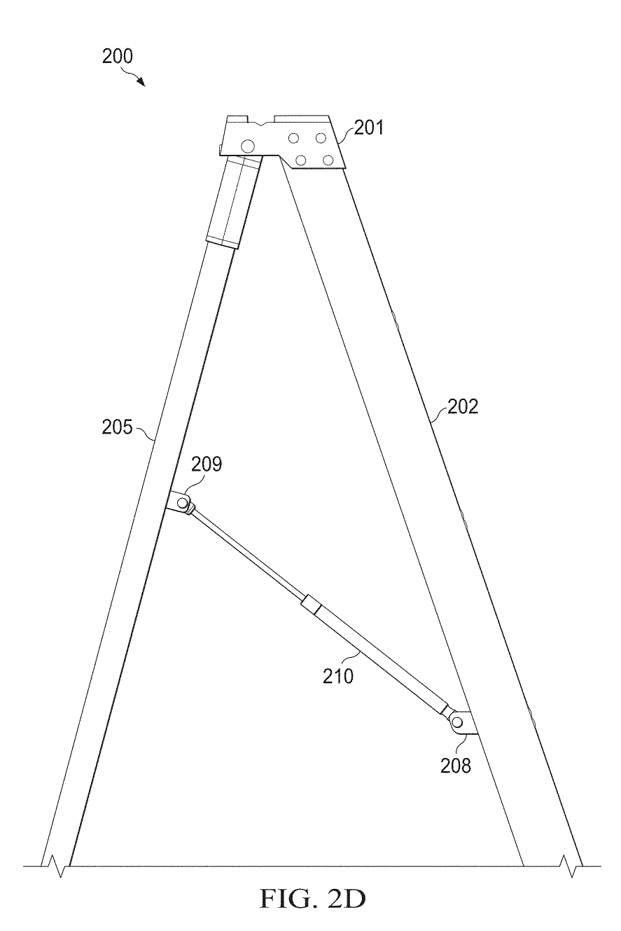

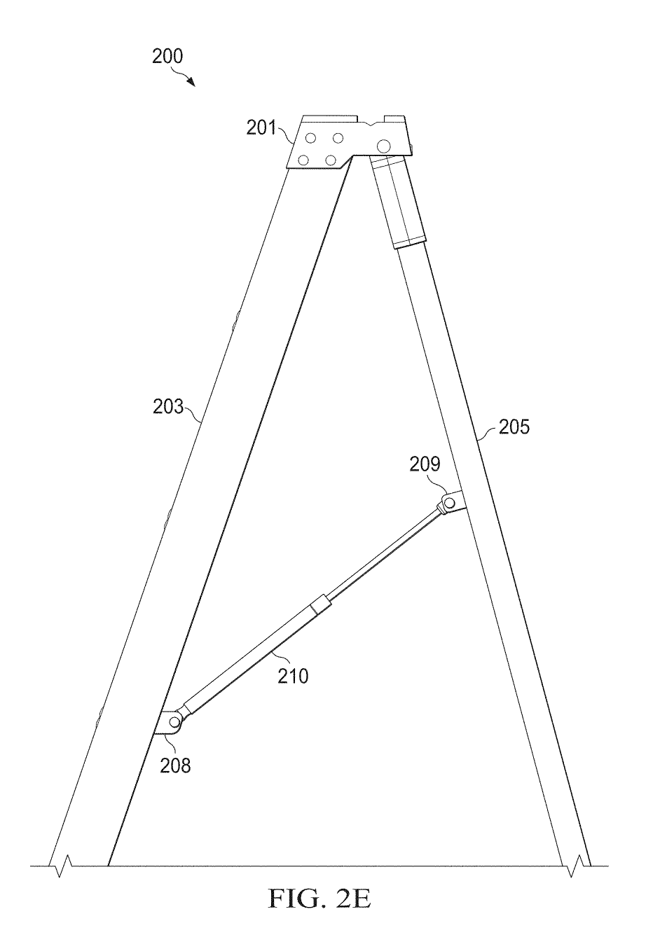

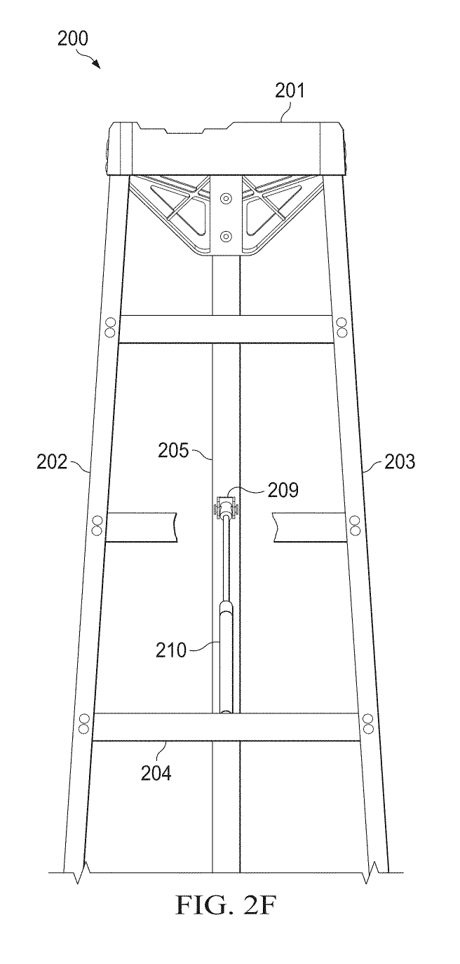

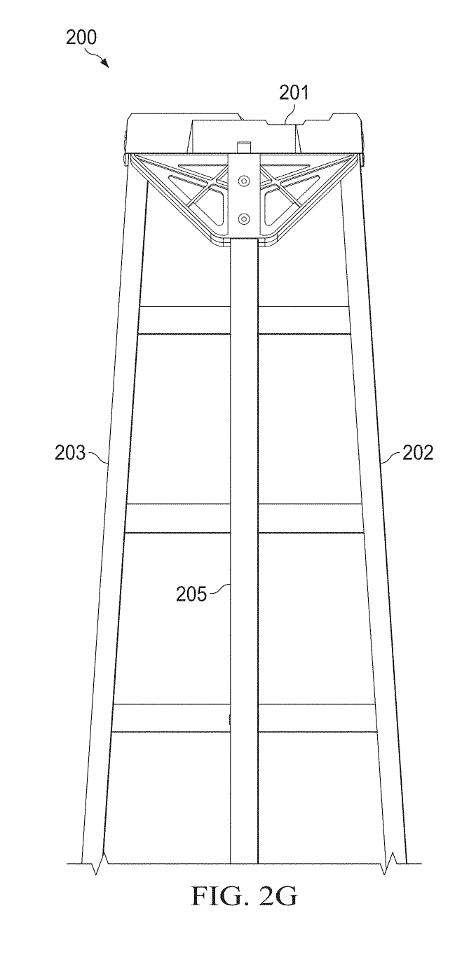

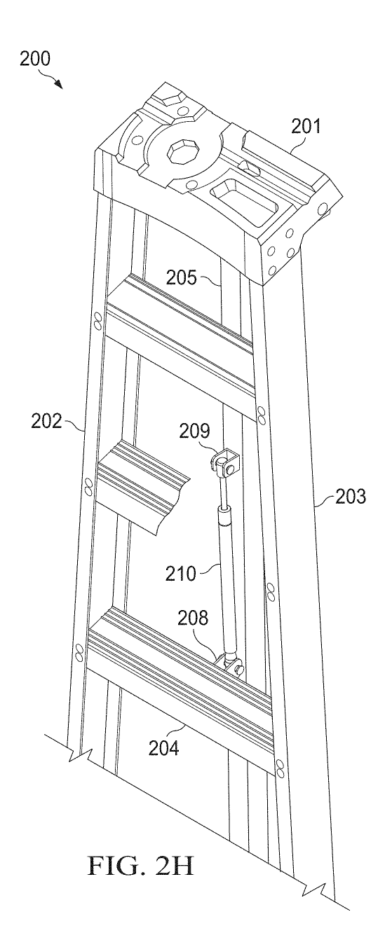

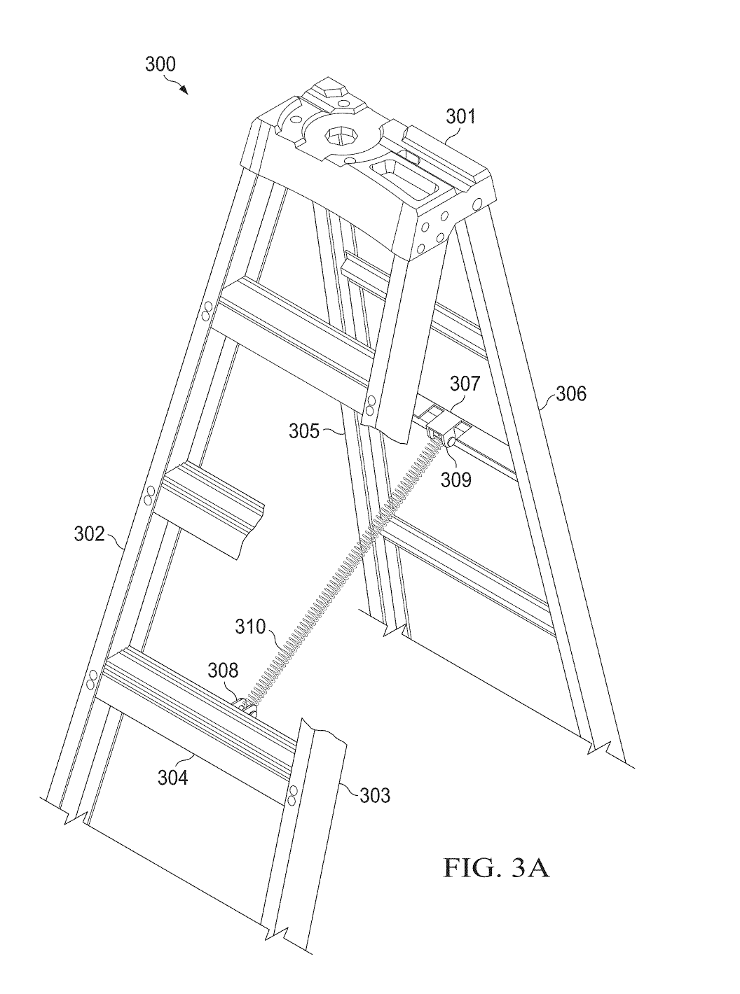

FIG. 2A illustrates a perspective view of a ladder 200 with three rails (or two rails and one leg) in an open configuration according to some embodiments, comprising a cap 201, first rail 202 of a first section, second rail 203 of a first section, step 204 of a first section, first rail 205 (or first leg 205) of a second section, SOF attachment 209 to a second section, and SOF 210. FIGS. 2B-2G illustrate different views for the same ladder 200 in an open configuration according to some embodiments, while FIG. 2H illustrates a perspective view of the same ladder 200 in a closed configuration according to some embodiments. Some of these views (e.g. FIG. 2H) further illustrate an SOF attachment 208 to a first section. Ladder 200 elements referred to in the description of FIG. 2A are labeled with the same reference numerals in FIGS. 2B-2H where visible. In some embodiments, a rail may comprise a leg. In other embodiments, a leg may comprise a rail. In still other embodiments, the terms “rail” and “leg” may be used interchangeably.

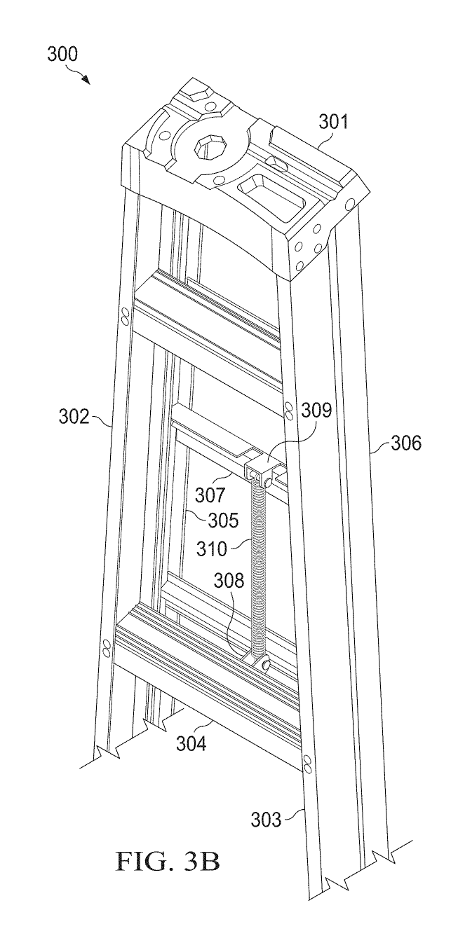

FIG. 3A illustrates a perspective view of a ladder 300 with four rails in an open configuration according to some embodiments, comprising a cap 301, first rail 302 of a first section, second rail 303 of a first section, step 304 of a first section, first rail 305 of a second section, second rail 306 of a second section, brace 307 of second section, SOF attachment 309 to a second section, and SOF 310. FIG. 3B illustrates the same elements in a closed configuration according to some embodiments.

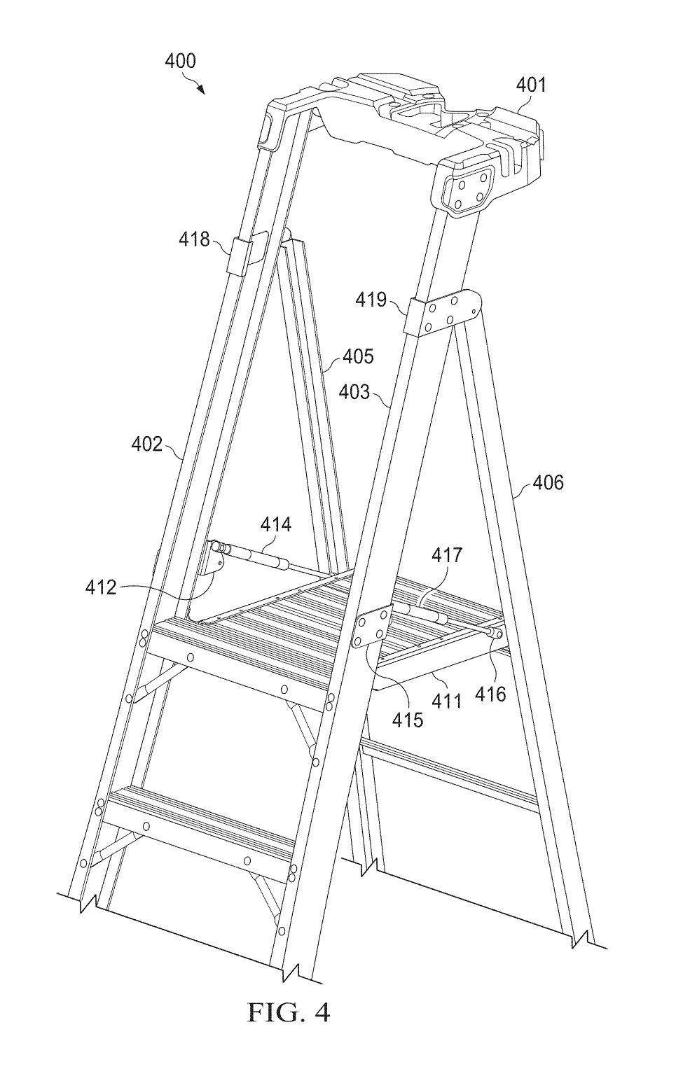

FIG. 4 illustrates a perspective view of a ladder 400 with four rails in an open configuration according to some embodiments, comprising a cap 401, first rail 402 of a first section, second rail 403 of a first section, first rail 405 of a second section, second rail 406 of a second section, platform 411, SOF attachment 412 to a first rail of the first section, SOF 414, SOF attachment 415 to a second rail of the first section and/or the platform, SOF attachment 416 to a second rail of a second section and/or platform, SOF 417, connector 418 attached to a first rail of a first section and a first rail of a second section, connector 419 attached to a second rail of a first section and second rail of second section. Any of the connectors described herein may be connected to a rail, a leg, an even or uneven surface such as a wall, a gripping surface, a cable or wire, etc.

### Ladder Connector

Referring to FIG. 1A, in some embodiments, a ladder cap 101 (or “top cap”) may be attached to at least one ladder section. In some embodiments, a cap 101 may further hinge a first section and a second section of a ladder 100, as illustrated in FIG. 1A. In some embodiments, a cap 101 may serve as a connector for a first section to be connected to a second section of a ladder 100. In some embodiments, a cap 101 may comprise the highest vertical position and/or edge of a ladder 100. In some embodiments, a “step ladder” may be a type of ladder comprising a cap which hinges a first ladder section and a second ladder section. In some embodiments, a cap 101 may not necessarily be intended for standing on and/or supporting downward force (e.g. of a human or other objects), whereas in other embodiments a cap 101 may be intended for standing on and/or supporting downward force. In some embodiments, a cap 101 may have functional grooves and/or holes (e.g. introduced via a molding process) in order to contain and/or support items associated with ladder activity (e.g. tools, small parts).

Referring to FIG. 4, in some embodiments, a cap 401 may not serve as a connector. In some embodiments, a cap 401 may not connect and/or hinge a first ladder section (e.g. comprising rails 402, 403) to or with a second ladder section (e.g. comprising rails 405, 406). For example, a connector 418, 419 may not comprise a cap 401 (and/or a cap 401 may not comprise a connector 418, 419). A connector 418, 419 may be attached to a ladder rail 402, 403 and may be distinct from a cap 401. For example, a non-cap connector 418, 419 may hinge a second ladder section (e.g. comprising rails 405, 406) to a first ladder section (e.g. comprising rails 402, 403) via connector hardware (e.g. a hinge joint, rivet). In some embodiments, alternatively or additionally, a platform 411 serves a connector for hinging or connecting the second ladder section (e.g. comprising rails 405, 406) to the first ladder section (e.g. comprising rails 402, 403) via connector hardware (e.g. a hinge joint, rivet).

In some embodiments, the ladder sections may be connected by one or more connectors. In some embodiments, a connector may comprise a cap, ladder support, SOF attachment, and/or spreader. Referring to FIG. 1A, for example, a cap 101 attaches a first ladder section and a second ladder section. Referring to FIG. 4, for example, a first section (comprised of rails 402, 403) and a second section (comprised of rails 405, 406) are attached by connectors 418, 419 and at least one of a platform 411 and SOF attachment 416. In some embodiments, a ladder section connector may allow angular displacement (e.g., any angle between 0 and 360 degrees) between the ladder sections with respect to one axis, one plane, one of the sections, and/or one or more points. Referring to FIG. 1A, for example, a cap 101 serving as a ladder section connector allows a second ladder section (comprising rails 105, 106 and brace 107) to be rotated with respect to an axis aligned with the two locations where attachment hardware (e.g. rivet, bolt, nut) attach the second ladder section to the cap 101. In some embodiments, a ladder section connector may comprise a hinge joint. Additionally or alternatively, in some embodiments, a ladder section connector may comprise one or more rivets. Additionally or alternatively, in some embodiments, a ladder section connector may comprise one or more bolts and/or nuts. Additionally or alternatively, in some embodiments, the ladder sections may be attached via a hinge joint near a ladder cap and/or near at least one ladder section edge. In some embodiments, a ladder section connector may be located near the edge of at least one of the ladder sections. In some embodiments, an angular displacement between the ladder sections may be configurable by moving one ladder section relative to the other ladder section about a ladder section connector (e.g. hinge joint near or within the ladder cap).

### Ladder Sections

In some embodiments, the ladder may comprise two sections. In some embodiments, each of the sections may comprise one or more other sections. In some embodiments, a ladder section may comprise one or more rails. For example, FIG. 1A illustrates a first rail 102 and second rail 103 of a first section, and a first rail 105 and second rail 106 of a second section. One the other hand, FIG. 2A only illustrates a first rail 202 and second rail 203 of a first section, and a first rail 205 of a second section. In a three-legged ladder such as that shown in FIG. 2A, the first rail 205 may also be referred to as the first leg 205. A rail may comprise one or more webs and one or more flanges. Referring back to FIG. 1A, a web may comprise an elongated section intended to prevent the ladder from bowing in a direction on a plane perpendicular to the axis of ladder section rotation when subjected to downward force, provide a location for user contact (e.g. in order to hold onto when climbing the ladder 100), and/or provide a location for attachment of another ladder element (e.g. step 104). A flange may comprise an elongated section potentially intended to prevent the ladder from bowing in a direction on a plane parallel to the axis of ladder section rotation when subjected to downward force, provide a location for user contact (e.g. in order to hold onto when climbing the ladder 100), and/or provide a location for attachment of another ladder element (e.g. step 104). For example, each of the first section rails 102, 103 comprise one web and two flanges, and a step 104 of the first section is at least attached to one flange of the first section rails 102, 103 (e.g. via bolts, nuts, and/or rivets, or the like). In some embodiments, a rail may comprise a leg. In some embodiments, a leg may comprise a rail. In some embodiments, the terms “rail” and “leg” may be used interchangeably to describe the same structure, whereas in other embodiments “rail and “leg” may connote different structures or one may comprise a subset of the other. In some embodiments, a rail may be distinguished from a leg depending on whether the rail is closed from all directions horizontally (in which the rail may be referred to as a leg) or whether the rail is open from at least one direction horizontally (in which case the rail may not be referred to as a leg). For example, FIG. 2B illustrates a ladder having 3 rails. However, in some embodiments, rails 202, 203 may not be referred to as legs whereas rail 205 may be referred to as a leg. In general, rails and/or legs may comprise a flanged, planar, rodular, or rectangular linear structure.

In some embodiments, one ladder section may be intended for a user (e.g. human) to climb, whereas the other section may not be intended for a human user to climb. For example, the first section of FIG. 1A (comprised of rails 102, 103 and step 104) may be intended for a user to climb, whereas the second section (comprised of rails 105, 106 and brace 107) may not be intended for a user to climb. However, in some embodiments, a first ladder and a second ladder section may both be intended for a user to climb.

### Ladder Supports

In some embodiments, a ladder section may comprise one or more supports that extend from one rail of the section to another rail of the section. In some embodiments, a step ladder may comprise supports, each of which is solely connected to a first ladder section or a second ladder section. In some embodiments, supports may be attached perpendicularly to ladder rails. In some embodiments, a support may comprise at least one of a step, brace, plate, cap, or platform, any connector described herein, etc., any of which may or may not be intended to support the force of entities positioned thereon. In some embodiments, any support or connector used for directly connecting two or more ladder sections or indirectly connecting two or more ladder sections, via one or more connectors, may be referred to as a connector. For example, FIG. 1A illustrates a step 104 from rail 102 to rail 103, and a brace 107 from rail 105 to rail 106. In some embodiments, one or more supports of a section may intended to be used to climb the ladder and/or support the force of entities positioned thereon. Referring to FIG. 1A, for example, a step 104 may be intended to be used to climb the ladder 100. In some embodiments, one or more supports of a section may not be intended to be used to climb the ladder and/or support the force of entities positioned thereon. Referring to FIG. 1A, for example, a brace 107 may not be intended to be used to climb the ladder 100. In some embodiments, a step may comprise a brace or a plate. In some embodiments, a brace may comprise a step or a plate. In some embodiments, a plate may comprise a step or a brace. In some embodiments, any of a step, brace, plate, cap, or platform may refer to any other of a step, brace, plate, cap, or platform. In some embodiments, a support intended or not intended to be used to climb the ladder may be intended to structurally stabilize the ladder. In some embodiments, a ladder support may comprise functional grooves, e.g. to increase traction between the step and an entity positioned thereon.

### Ladder Configuration

In some embodiments, a ladder may be configured in an open or a closed configuration. For example, FIGS. 1A-1G illustrate a ladder 100 in an open configuration, whereas FIGS. 1H-1N illustrate the same ladder 100 in a closed configuration. In some embodiments, a ladder in the closed position may comprise substantially parallel ladder sections, as seen in FIGS. 1H-1N. For example, FIG. 1K illustrates a first section rail 102 substantially parallel to a second section rail 105, in contrast to the same rails 102, 105 of the same ladder 100 from the same view in an open configuration, as illustrated in FIG. 1D. In some embodiments, a ladder in the open position may comprise angled sections, where the span of the angled sections is widest at the ladder base. For example, the span of the angled rails 102, 105 of the ladder sections of the ladder 100 illustrated in FIG. 1D increases as one moves down from the top of the ladder. In some embodiments, the ladder sections may have an angular displacement when the ladder is in an open position, as seen in FIG. 1D.

### System Opening Facilitator (SOF)

In some embodiments, the ladder may comprise one or more system-opening facilitators (SOFs). For example, FIG. 1A illustrates an SOF 110 comprising a gas strut. In some embodiments, an SOF 110 itself may comprise attachments, while in other embodiments, attachments may be distinct from an SOF 110. For example, attachments may be included with an SOF upon delivery by an SOF manufacturer, or attachments may be provided by a ladder manufacturer. In some embodiments, an SOF may be attached to a first section (e.g. the section of FIG. 1A comprising rails 102, 103 and step 104) and a second section (e.g. the section of FIG. 1A comprising rails 105, 106 and brace 107). Referring to FIG. 1A, in some embodiments, the attachments 108, 109 may attach an SOF 110 directly to ladder supports (e.g. step 104, brace 107, or plate).

Referring to FIG. 4, in some embodiments, an SOF 414, 417 may attach to at least one of a rail 402, 403, 405, or 406, platform 411, or ladder support. In some embodiments, an SOF may generally exert outward force and increase in length as ladder sections open (i.e. as the angular displacement between ladder sections increase). Referring to FIG. 1A, in some embodiments, an SOF may attach to a ladder section support (e.g. step 104, brace 107, or plate) on top of the support, on bottom of the support, or on either side of the support. Additionally, in some embodiments, a ladder support may comprise a portion receptive to the attachment of an SOF. For example, the brace 107 of FIG. 1A illustrates a partial cutaway proximal to the attachment 109 of the SOF 110. In some embodiments such as that shown in FIG. 1A, a strut may comprise an outer cylinder and inner piston. In some embodiments, a strut may be slidably disposed along one axis.

In some embodiments, an SOF may comprise one or more SOFs. In some embodiments with more than one SOF, the multiple SOFs may be substantially parallel. In some embodiments with an SOF comprising more than one SOFs, the multiple SOFs may not be parallel and may be angular with respect to each other. For example, FIG. 4 illustrates one or more substantially parallel SOFs 414, 417. The SOFs 414, 417 of FIG. 4 may comprise one SOF or two distinct SOFs. In some embodiments, one or more SOFs may be attached to the ladder sections at the same positions. In some embodiments, one or more SOFs may be attached to the ladder sections at different positions. In some embodiments, an SOF may comprise at least one of a gas strut (or gas spring), coil spring, electrically-powered strut (e.g. via electric motor), leaf spring, linear rate spring, variable rate spring, or any compressible mechanical device/mechanism and/or resilient material that can provide outward force (e.g. spring, rubber, etc.). For example, a variable rate spring or SOF exerting variable outward force may be configured to provide less force or more force when the SOF is more compressed than when it is less compressed. For example, an SOF exerting less force when the SOF is more compressed may rely more on the human user to provide force to initiate the ladder opening, but may also allow easier closing of the ladder when the ladder sections are initially closed. The SOF material may comprise, plastic, metal, and/or or other materials commonly used for springs and/or hydraulic devices. Additionally, the SOF material may be chosen in order to achieve and/or avoid certain properties (e.g., with regard to magnetism, electric polarization, electric conduction, thermal conduction, oxidization). For example, FIG. 3A illustrates an SOF comprising a coil spring 310. In some embodiments, an SOF may be non-straight (e.g. a leaf spring or an SOF foldable at one or more points, such as an electric-powered door opener). For example, such a non-straight SOF may extend to a straight or wide-angled position when open, and fold to a zero- or narrow-angled position when closed (e g similar to a ladder spreader). In some embodiments, an SOF may be configured in one or more configurations depending on the ladder configuration. For example, an SOF could be compressed when the ladder is closed, and extended when the ladder is open.

In some embodiments, an SOF may be substantially vertical when an SOF is in a compressed configuration and/or when a ladder is in a closed configuration. For example, see the configuration of SOF 110 in FIG. 1K. On the other hand, in some embodiments, an SOF may be substantially non-vertical and/or horizontal when an SOF is in an extended configuration and/or when a ladder is in an open configuration. For example, see the configuration of SOF 110 in FIG. 1D.

In some embodiments, one or both ends of an SOF may rotate with respect to at least one axis when the ladder is being configured to a different configuration (e.g. when a ladder is being opened or closed). Referring to FIG. 1K, for example, in order for the SOF 110 to achieve the configuration of the SOF 110 of FIG. 1D, it may be necessary for one or more ends of the SOF 110 to rotate and/or pivot about one or more of the axes coming out of the page and/or going into the page proximal to the SOF attachments 108, 109. This rotation may be achieved, e.g. with at least one SOF attachment 108, 109 comprising a hinge joint, rivet, and/or male and female joint.

### SOF Attachment

In some embodiments, an SOF may comprise attachment hardware that facilitates attachment to the ladder. In some embodiments, an SOF may not comprise attachment hardware. For example, attachment hardware may be distinct from the SOF and separately provided and/or installed. In some embodiments, an SOF may be attached to the ladder by its end points which may comprise attachment hardware. In some embodiments, an SOF may be attached to the first and/or second section of the ladder. In some embodiments, an SOF attachment may be achieved at least in part by a screw, bolt, nut, rivet, male connector, female connector, hook, latch, hinge, adhesive, etc. Referring to FIG. 1A, for example, the SOF attachments 108,109 may comprise a rivet or a male and female connector. In some embodiments, the term “connector” may also refer to any type of support described herein. In some embodiments, an SOF attachment may allow for SOF rotation with respect to at least one axis. For example, a rivet may allow for an SOF to rotate along one axis (e.g., x-axis, y-axis, z-axis, a diagonal axis, an axis substantially perpendicular to a portion of a ladder such as a rail, a section, a platform, a step, etc., or any other axis). Referring to FIG. 1A, for example, the ends of the SOF 110 may be rotatable about an axis parallel with the ladder supports 104, 107 that the SOF 110 is attached to. As another example, a male (e.g. ball-like) connector may fit into a female connector (e.g. with holes and/or curved depressions) in order to facilitate SOF rotation with respect to one or more axes. The connectors may be attached or built into at least one of the ladder or the SOF. In some embodiments with a male and female connector, the male connector may correspond to the attachment side closer to either the ladder or the SOF. In some embodiments, a ladder may comprise a bracket to facilitate the attachment of an SOF. In some embodiments, the bracket may be further attached to a ladder section via a ladder support. In some embodiments a ladder support may also function as a bracket to attach an SOF. Referring to FIG. 1K, for example, a ladder brace 107 attaches to an SOF attachment 109 to a second section; the brace 107 therefore might also be referred to as a bracket. In some embodiments, a ladder with two first section rails and two second section rails may comprise an SOF.

In general, an SOF may be oriented in either direction with respect to the ladder sections. For example, in SOF 110 embodiments comprising a gas strut as illustrated in FIG. 1A, the outer cylinder may be proximal to the first ladder section or the second ladder section when the ladder 100 is in an open position. Additionally, the angle of attachment between the SOF 110 and the ladder sections when the ladder 100 is in an open position may vary depending on the embodiment. In some embodiments, the SOF 110 may be attached to a ladder section such that the angle between the SOF 110 and the plane intersecting an SOF attachment 108 and parallel to the floor supporting the ladder 100 is approximately 30° when the ladder is in an open position. In other embodiments, the angle between the SOF 110 and the plane intersecting an SOF attachment 108 and parallel to the floor supporting the ladder 100 may be approximately 45° when the ladder is in an open position. The SOF ends may be attached at the appropriate points on each ladder section in order to realize the desired angle of attachment. In some embodiments, the SOF attachment to the first ladder section may be vertically higher than the SOF attachment to the second ladder section when the ladder is in an open position. in other embodiments, the SOF attachment to the second ladder section may be vertically higher than the SOF attachment to the first ladder section when the ladder is in an open position.

In some embodiments with four rails, an SOF may attach to a step associated with the first section and a step, brace, plate, etc., associated with the second section. In some embodiments with four rails, an SOF may attach to a first section rail and a second section rail. In some embodiments, a ladder with two first section rails and one second section rail may comprise an SOF. In such embodiments with three rails, an SOF may attach to a step associated with the first section and a rail associated with the second section. Referring to FIG. 2A, for example, an SOF 210 is attached to a support 204 of a first section and a rail 205 of a second section. In some embodiments, an SOF may be attached to a ladder step and a ladder leg or rail. In some embodiments, an SOF may be attached from a first section rail on one side to a second section rail on either side (e.g., substantially parallel with respect to an axis or angular with respect to an axis). In some embodiments, an SOF may be attached from a first section rail to a second section step. Referring to FIG. 4, for example, an SOF 414, 417 is attached from first section rails 402, 403 to second section rails 405, 406 and/or a platform 411, which may be a type of ladder support.

### SOF Functionality

In some embodiments, an SOF may assist a person opening the ladder by automatically completing the opening process after the opening process has been initiated by the person. In some embodiments with two ladder sections, the opening process may be initiated by pushing or pulling one ladder section away from the other ladder sections. Following the initiation of the opening process, the opening process may be continued and/or completed by triggering (e.g., automatically triggering) an SOF to exert outward force and/or complete an opening of the ladder (e.g. by pressing a button to start an electric motor-powered strut). In some embodiments, the triggering of an SOF may occur immediately after a sufficient force is exerted on at least one of the ladder sections (e.g. after one of the ladder sections is pushed away sufficiently hard from the other ladder section). In some embodiments, an SOF may provide outward force or resistant force that would need to be overcome when closing the ladder (e.g., in the case of a spring). In other embodiments, an SOF may provide no outward force during the closing process (e.g., in the case of a disengageable electric motor-powered strut). In other embodiments, an SOF may provide inward force during the closing process (e.g. in the case of a reverse engaged electric motor-powered strut). In some embodiments, an SOF may be configured to allow an external interaction to reduce or disable the opening force associated with the SOF. For example, in some embodiments with an electric motor-powered strut, a button may be provided for pressing by a user to disable the motor-powered strut while the user attempts to close the ladder.

In some embodiments, more than one SOF may be used (e.g., to provide additional opening force, which may be useful for larger or heavier ladders). In some embodiments with more than one SOF, the more than one SOFs may be attached in parallel (e.g. to rails and/or steps and/or other SOFs). For example, see FIG. 4. In some embodiments, more than one SOFs (or an SOF comprising more than 1 SOF) may be attached in series (e.g. such that there is at least one SOF-to-SOF attachment). This may provide, e.g., increased SOF length and/or outward force. Additionally, using more than one SOF in series may allow for easy modification of an SOF for different ladder types, e.g., in the case where off-the-shelf SOFs from a third party are used. In some embodiments, an SOF can rotate and/or pivot to provide useful outward force as the ladder opens. For example, an SOF may be able to rotate about the axis parallel to a ladder step or brace. Such a range of motion would allow an SOF to be automatically readjusted throughout the opening process.

### Ladder Spreader and SOF

In some embodiments, a ladder may comprise one or more spreaders. In some embodiments, the spreader may be attached to a first section and a second section. In some embodiments, the spreader may fold depending on the configuration of the ladder. For example, the spreader may comprise at least two segments which become parallel when the ladder is in a closed position. In some embodiments, the spreader may be configured along a common line when the ladder is in the open position. For example, a spreader may extend horizontally between a first section and a second section when a ladder is fully opened. In some embodiments, the spreader may provide locking functionality and/or structural stability to a ladder in at least one configuration. For example, a spreader may be manually and/or automatically engaged when the ladder is in an open position (e.g. in order to maintain the ladder in an open position). For example, a spreader comprising at least two segments may further comprise a spreader lock that may limit the range of motion of the spreader segments. For example, a spreader lock may prevent two or more segments of a spreader from further angling downward after achieving a horizontal configuration, and such a spreader lock may be attached to and positioned above the two or more spreader segments. In some embodiments, the spreader may prevent the ladder from becoming configured in a certain way. For example, a spreader may only allow the ladder sections to span a limited distance based on the length of the spreader and the attachment points of the spreader to the ladder sections.

In some embodiments involving a spreader, an SOF may be positioned above a spreader, while in other embodiments, an SOF may be below a spreader. Additionally, an SOF may be positioned at substantially the same height as the spreader. Such positioning may be chosen in part based on achieving a desired amount of SOF force and/or positioning an SOF advantageously in view of human use (e.g. for safety and/or for providing open space in a desired ladder area).

In some embodiments, a spreader may comprise an SOF. In such an embodiment, an SOF itself may provide locking functionality when the ladder is in the open position in order to maintain the ladder in a stable open position during use. For example, a gas strut or other SOF may latch after extending a certain amount, and further require the user to unlatch the gas strut in order to close the ladder. In another example, an electric motor-powered strut or other SOF may engage a lock after extending to a certain amount, and further require the user to disengage the strut lock in order to close the ladder.

### Ladder Opening Process

In some embodiments, the opening process may be initiated by a force applied by the user to a first ladder section and/or a second ladder section. For example, a user may push one ladder section away from the other ladder section, or pull two ladder sections apart. A user may refer to a person, a robot, a computing system, a motor vehicle, etc. In some embodiments, an SOF may not provide outward force until the opening process has been initiated. In other embodiments, an SOF may provide outward before or during initiation of the opening process. In other embodiments, an SOF may continually provide outward force (e.g., before the initiation process), but may not provide enough outward force to modify the configuration (e.g. open) the ladder until after an opening process has been initiated by an external force. For example, an external force (e.g. user or gravity) may initiate the opening process by starting to push one ladder section away from the other section (e.g. such that the angular displacement of the two sections about one or more hinge joints increases), and one or more SOFs may automatically (i.e. without any additional action beyond initiating the ladder opening process) complete the opening process without additional force required from the external force (e.g. person or gravity). When the opening process is completed, the angular displacement of the two sections about the one or more hinge joints reaches its maximum possible angular displacement.

In some embodiments, an SOF may be triggered to complete an opening process once the ladder has been configured from a closed configuration to a preliminary open configuration associated with less than the maximum possible angular displacement as described previously. In some embodiments, an initiating force may configure a ladder from a closed configuration to an initially open or a preliminary open configuration or state. In some embodiments, an opening force may configure a ladder from a closed and/or preliminary open configuration to a fully open (or just “open”) configuration. In some embodiments, an initiating force may be less than an opening force. In some embodiments, the angular displacement of the ladder sections associated with an initiation force may be less than the angular displacement of the ladder sections associated with an opening force. In some embodiments, triggering an SOF to complete the opening of a ladder may occur after achieving a certain angular displacement between the ladder sections (e.g. after the ladder sections have been initially opened from a closed configuration).

In some embodiments, one or more SOFs may provide an initiation force while one or more other SOFs may provide an opening force. In some embodiments, an SOF may provide an initiation force and an opening force. Additionally or alternatively, an SOF may provide a closing force for reducing the angular displacement between the two ladder sections until the two ladder sections are substantially parallel to each other.

In some embodiments, a user may statically fix one ladder section during the opening process (e.g. by standing on the one ladder section) while an SOF automatically completes the opening process. For example, the user may fix a first ladder section to the ground (e.g. by pressing down ladder section support via foot) while lifting a second ladder section off the ground in order to further facilitate the opening process via an SOF. “Lifting” of a ladder section in this process may comprise rotating the base of the ladder about the fixed point.

In some embodiments, the external force (e.g., the force for initiating the opening of the ladder, the force for completing the opening of the ladder, the force for closing the ladder, etc.) may be applied manually by a human. In some embodiments, the external force may be provided by gravity (e.g. by appropriately position the ladder). In some embodiments, the external force may be provided by a pulled member (e.g. line attached to at least one ladder section), e.g. with the pulled member being pulled by a human. In some embodiments, the external force may be provided by an additional SOF attached to the ladder which is able to initiate but not complete the opening process. In some embodiments, the external or opening force provided during the beginning of the opening process (e.g. the force provided by a human) may be less than the external or opening force provided by an SOF during the remainder of the opening process.

### Platform Ladder

In some embodiments, a ladder may comprise a connector and at least two sections, each of the two sections comprising at least one support. In some embodiments, a ladder may comprise a platform ladder. In some embodiments, the platform ladder may comprise a platform supported by a first ladder section and/or a second ladder section, and located above all, or at least some, ladder supports. In some embodiments, the platform may be intended to support the force of entities positioned thereon. In some embodiments, a ladder may refer to a step ladder and/or platform ladder. In some embodiments, a ladder, step ladder, or platform ladder may be referred to as a ladder system, step ladder system, or platform ladder system, respectively.

In some embodiments, a platform ladder may be distinguished from a step ladder in that the highest vertical support of a step ladder may not be intended for standing thereon and/or does not provide a structurally stable surface for supporting a large object (e.g. user or bucket), whereas the highest vertical support of a platform ladder may be intended for standing thereon and/or does provide a structurally stable surface for supporting a large object (e.g. a user or bucket). Referring to FIG. 4 for example, if one did not consider the cap 401 to be a support, then the platform 411 would be the highest vertical support, and thus may justify referring to the ladder 400 as a platform ladder. In some embodiments, a platform ladder may be distinguished from a step ladder based on the location of the ladder section connectors. For example, FIGS. 1A-1N, 2A-2H, and 3A-3B all illustrate embodiments of ladder connectors 101, 201, 301 (e.g. embedded in cap) that hinge both ladder sections near their highest vertical positions. On the other hand, FIG. 4 illustrates an embodiment of a ladder connector 418,419, that does not hinge both ladder sections near their highest vertical positions. Thus, in some embodiments, the ladders illustrated in FIGS. 1A-1N, 2A-2H, and 3A-3B may be referred to as step ladders, whereas the ladder illustrated in FIG. 4 may be referred to as a platform ladder. In some embodiments, a platform ladder may be distinguished from a step ladder in that a platform ladder may comprise a support (e.g. platform) that attaches to both ladder sections below their highest vertical position, whereas a step ladder may not comprise a support (e.g. platform) that attaches to both ladder sections below their highest vertical position. For example, FIG. 4 illustrates a platform 411 that attaches to both sections of the ladder 400, one ladder section comprising the rails 402, 403 and the other ladder section comprising the rails 405, 406.

### Ladder Line

In some embodiments a line may be attached to one ladder section in order to facilitate closing the ladder. For example, a line may be attached to the support of a second section of a ladder in order to facilitate closing the ladder from a user most proximal to a first section of the ladder (e.g. by manually pulling the line from second section towards the first section). Alternatively or additionally, in some embodiments, a line may be attached to the first ladder section to allow pulling the line in the direction from the first ladder section toward the second ladder section, and/or in the direction from the second ladder section toward the first ladder section.

The line may be manually pulled by a human in the direction from the first ladder section toward the second ladder section, or vice versa, in order to apply force to overcome the outward force of an SOF. Note that embodiments involving a line may have additional attachment and/or guide hardware at the section the line is pulled from, e.g. in order to maintain the line in a convenient location for user manipulation and/or to keep the line position stable during the closing process. For example, a loop may be attached to a ladder section different from the ladder section to which the line is attached, with the intention that the line will be pulled through the loop.

In some embodiments, the line may be attached to a far ladder section (e.g., with respect to the position of the user) via a step, brace, or plate. In some embodiments, the line may be attached to a near ladder section (e.g., with respect to the position of the user) via a step, brace, or plate. For example, the step, brace, or plate of a near ladder section may comprise an aperture (e.g. underneath the step, brace or plate) that serves to prevent the line from being pulled through the aperture (e.g. if the near line end is larger than the middle line segment) and/or to guide the line during the closing process.

In some embodiments, the line may comprise a rope, cord, string, tube, band, or other elongated device to facilitate pulling. In some embodiments, the line may comprise a handle and/or grip-enhancing features along its length. In some embodiments, the line may be flexible. In other embodiments, the line may be inflexible. In some embodiments, the line may be inelastic. In other embodiments, the line may be elastic.

### Ladder Composition

In some embodiments, the ladder material (including the material of a cap, rail, leg, web, flange, connector, hinge, attachment, support, step, brace, plate, platform, SOF, or line) may comprise at least one of aluminum, fiberglass, plastic, wood, etc.

In some embodiments, ladder rails may comprise friction-enhancing feet near the bottom of the rails. For example, the feet may be rubber and/or grooved covers for the bottom of the rails. In some embodiments, the feet may be used to prevent movement of the ladder base while statically configured and/or during configuring of the ladder from one configuration to another configuration. For example, friction-enhancing ladder feet may be advantageous in order to secure at least one section of a ladder while force is applied to at least one other section of the ladder in order to realize a change of configuration of the ladder.

In some embodiments, ladder rails, legs, steps, braces, plates, platforms, feet, spreaders, and/or spreader locks may be attached to one another via screws, bolts, nuts, rivets, male connectors, female connectors, hooks, latches, hinges, adhesive, etc. In some embodiments, any ladder component may be attached to any other ladder component at least in part by a screw, bolt, nut, rivet, male connector, female connector, hook, latch, hinge, adhesive, etc. A male connector may be substantially concave (e.g. the ball of a ball joint) whereas a female connector may be substantially convex or comprise an aperture (e.g. the receiving portion of a ball joint).

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A ladder system comprising:
a first section comprising: a first rail, a second rail, and a first support connected to the first rail and the second rail;
a second section comprising a first leg;
a first connector for connecting, either directly or indirectly via one or more second connectors, the first section to the second section; and
a ladder system-opening facilitator connected to the first section and the second section,
wherein the first section is substantially parallel to the second section when the ladder system is in a closed position,
wherein the ladder system-opening facilitator automatically completes an opening action for the ladder system in response to initiation of the opening action, and
wherein the first section is angular to the second section when the ladder system is in an open position.

2. The ladder system of claim 1, wherein the initiation of the opening action comprises application of first force to at least one of the first section or the second section.

3. The ladder system of claim 2, wherein the first force is provided by a source external to the ladder system.

4. The ladder system of claim 2, wherein the first force is less than a second force for both initiating and completing the opening action.

5. The ladder system of claim 2, wherein the first force is less than a second force for completing the opening action.

6. The ladder system of claim 1, wherein the ladder system-opening facilitator provides a force for automatically completing the opening action.

7. The ladder system of claim 1, wherein the first connector or the one or more second connectors comprises at least one of a cap, a platform, a step, a plate, a brace, a hinge, or a rivet.

8. The ladder system of claim 1, wherein the first support is positioned substantially perpendicularly to at least one of the first rail or the second rail.

9. The ladder system of claim 1, wherein the first connector or the one or more second connectors is positioned near an edge of at least one of the first section or the second section.

10. The ladder system of claim 1, wherein the ladder system comprises a step ladder system.

11. The ladder system of claim 1, wherein the ladder system comprises a platform ladder system.

12. The ladder system of claim 1, wherein the ladder system-opening facilitator is connected to the first rail and the first leg.

13. The ladder system of claim 1, wherein the ladder system-opening facilitator is connected to the first support and the first leg.

14. The ladder system of claim 1, wherein the first leg comprises a third rail, wherein the second section further comprises a fourth rail and a second support, and wherein the second support is connected to the third rail and the fourth rail.

15. The ladder system of claim 14, wherein the ladder system-opening facilitator is connected to the first rail and the third rail.

16. The ladder system of claim 14, wherein the ladder system-opening facilitator is connected to the first rail and the fourth rail.

17. The ladder system of claim 14, wherein the ladder system-opening facilitator is connected to the first support and the second support.

18. The ladder system of claim 1, wherein the ladder system-opening facilitator comprises a gas strut.

19. The ladder system of claim 1, wherein the ladder system opening facilitator comprises a compressible mechanical device.

20. The ladder system of claim 1, wherein the ladder system-opening facilitator comprises an electric motor.

21. The ladder system of claim 1, wherein the ladder system-opening facilitator comprises a spring.

22. The ladder system of claim 1, wherein the ladder system-opening facilitator comprises multiple ladder system-opening facilitators.

23. The ladder system of claim 22, wherein the multiple ladder system-opening facilitators are substantially parallel to each other.

24. The ladder system of claim 22, wherein the multiple ladder system-opening facilitators are substantially in series to each other.

25. The ladder system of claim 1, further comprising a spreader.

26. The ladder system of claim 25, wherein the ladder system-opening facilitator is located above the spreader.

27. The ladder system of claim 25, wherein the ladder system-opening facilitator is located below the spreader.

28. The ladder system of claim 25, wherein the spreader comprises the ladder system-opening facilitator.

29. The ladder system of claim 1, wherein the second section comprises a second leg.

30. The ladder system of claim 29, wherein the second section comprises a second support connected to the first leg and the second leg.

31. The ladder system of claim 30, wherein the ladder system-opening facilitator is connected to the first support and the second support.

32. The ladder system of claim 30, wherein the ladder system-opening facilitator is connected to the first rail and the second support.

33. The ladder system of claim 1, wherein at least a portion of the first section or the second section is manufactured with at least one of aluminum, fiberglass, plastic, or wood.

34. The ladder system of claim 1, further comprising a line connected to at least the second section.

35. The ladder system of claim 34, wherein pulling a portion of the line towards the first section causes the ladder system to enter a closed position.

36. The ladder system of claim 35, wherein a force associated with pulling the portion of the line towards the first section is greater than a resistant force provided by the ladder system-opening facilitator.

37. A ladder system comprising:
a first section comprising: a first rail, a second rail, and a first support connected to the first rail and the second rail;
a second section comprising a first leg;
a first connector for connecting, either directly or indirectly via one or more second connectors, the first section to the second section; and
a ladder system-opening facilitator connected to the first section and the second section,
wherein the first section is substantially parallel to the second section when the ladder system is in a closed state,
wherein the first section is at a first angle to the second section when the ladder system is in an initial open state,
wherein the ladder system moves from the closed state to the initial open state upon application of external force to at least one of the first section or the second section,
wherein the first section is at a second angle to the second section when the ladder system is in a final open state, and
wherein the ladder system-opening facilitator causes the ladder system to move from the initial open state to the final open state.

38. The ladder system of claim 37, wherein the ladder-opening facilitator provides force for causing the ladder system to move from the initial open state to the final open state.

39. The ladder system of claim 37, wherein when the ladder system moves to the initial open state, the ladder system-opening facilitator is automatically triggered to cause the ladder system to move from the initial open state to the final open state.

40. A ladder system comprising:
a first section comprising: a first rail, a second rail, and a first support connected to the first rail and the second rail;
a second section comprising a first leg;
a first connector for connecting, either directly or indirectly via one or more second connectors, the first section to the second section; and
a ladder system-opening facilitator connected to the first section and the second section,
wherein in response to first angular displacement between the first section and the second section, the ladder system-opening facilitator automatically causes second angular displacement between the first section and the second section, and
wherein the second angular displacement is greater than the first angular displacement.
